(19) United States
(12) Patent Application Publication
(10) Pub. No.: US 2013/0088275 A1
(43) Pub. Date: Apr. 11, 2013

(54) DYNAMIC VOLTAGE DROP AWARE CLOCK INSERTION TOOL

(71) Applicants: Martin Fennell, City of Iver Heath (GB); Iain Stickland, City of Yateley (GB); James G. Monthie, City of Fulton, MD (US)

(72) Inventors: Martin Fennell, City of Iver Heath (GB); Iain Stickland, City of Yateley (GB); James G. Monthie, City of Fulton, MD (US)

(73) Assignee: LSI Corporation, Milpitas, CA (US)

(21) Appl. No.: 13/267,132

(22) Filed: Oct. 6, 2011

(51) Int. Cl. G06F 1/04

(52) U.S. Cl. 327/292

(57) ABSTRACT

A clock tree power decoupling system includes a pre-decoupling processor that provides a clock tree that supports a critical timing path condition. The clock tree power decoupling system also includes a clock tree power decoupler having a clock tree module that identifies clock buffers in the clock tree corresponding to synchronous start and end points of the critical timing path condition, and a power decoupling module that inserts a decoupling capacitance proximate the clock buffers in the clock tree, wherein the decoupling capacitance is sized to rectify the critical timing path condition. The clock tree power decoupling system additionally includes a post-decoupling processor that provides a power-decoupled clock-inserted database employing the decoupling capacitance. A method of clock tree power decoupling is also provided.

### TECHNICAL FIELD

This application is directed, in general, to an electronic design tool and, more specifically, to a clock tree power decoupler, a method of clock tree power decoupling and a clock tree power decoupling system.

### BACKGROUND

The innovation of clock-based design has allowed digital integrated circuits (ICs), in general, and System on Chip (SoC) designs, in particular, to flourish. Clocking effectively quantizes time thereby enabling solid state circuits to be abstracted to sequential state machines and further into straight forward and intuitive programming paradigms for chip design. The fundamental assumption involving sequential state machines is the assumption of sequential execution where all parts stay “in step” with each other. This assumption dictates a first constraint that a clocked circuit always makes a step at an intended clock time and a second constraint that the clocked circuit makes no more than one step at the intended clock time.

Ideally, clock trees are designed to assure that these two constraints are met. In practice, on-chip clock trees are subject to power supply coupling effects that produce clock timing jitter, which may cause the first or second constraint to be violated on a regular or intermittent basis. On the other hand, excessive power supply decoupling typically causes excessive leakage current in the IC or SoC design, thereby wasting power. Overcoming power supply based clock jitter with a lower leakage solution would prove beneficial to the art.

### SUMMARY

Embodiments of the present disclosure provide a clock tree power decoupler, a method of clock tree power decoupling and a clock tree power decoupling system.

In one embodiment, the clock tree power decoupler includes a clock tree module configured to identify clock buffers in a clock tree corresponding to synchronous start and end points of a critical timing path condition. Additionally, the clock tree power decoupler includes a power decoupling module configured to insert a decoupling capacitance proximate the clock buffers in the clock tree, wherein the decoupling capacitance is sized to rectify the critical timing path condition.

In another aspect, the method of clock tree power decoupling includes identifying clock buffers in a clock tree corresponding to synchronous start and end points of a critical timing path condition and inserting a decoupling capacitance proximate the clock buffers in the clock tree, wherein the decoupling capacitance is sized to rectify the critical timing path condition.

In yet another aspect, the clock tree power decoupling system includes a pre-decoupling processor that provides a clock tree that supports a critical timing path condition. The clock tree power decoupling system also includes a clock tree power decoupler having a clock tree module that identifies clock buffers in the clock tree corresponding to synchronous start and end points of the critical timing path condition, and a power decoupling module that inserts a decoupling capacitance proximate the clock buffers in the clock tree, wherein the decoupling capacitance is sized to rectify the critical timing path condition. The clock tree power decoupling system additionally includes a post-decoupling processor that provides a power-decoupled clock-inserted database employing the decoupling capacitance.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

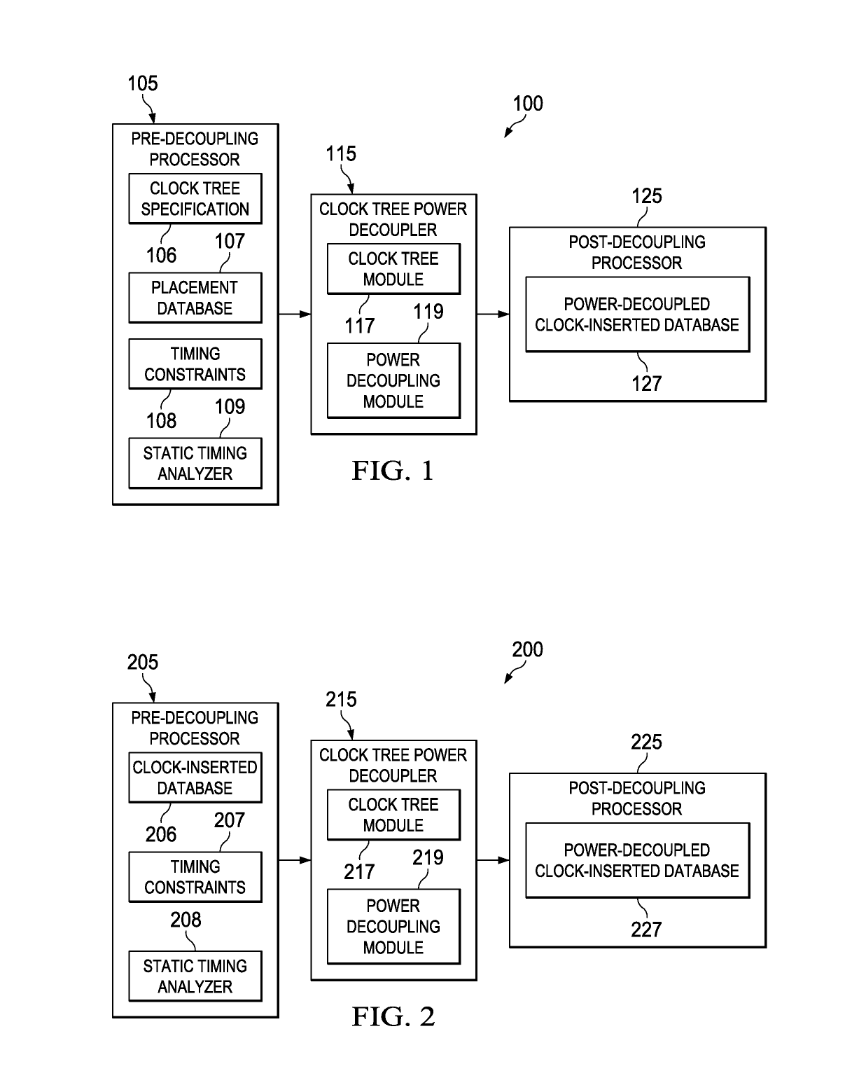

FIG. 1 illustrates a system diagram of an embodiment of a clock tree power decoupling system constructed according to the principles of the present disclosure;

FIG. 2 illustrates a system diagram of another embodiment of a clock tree power decoupling system constructed according to the principles of the present disclosure;

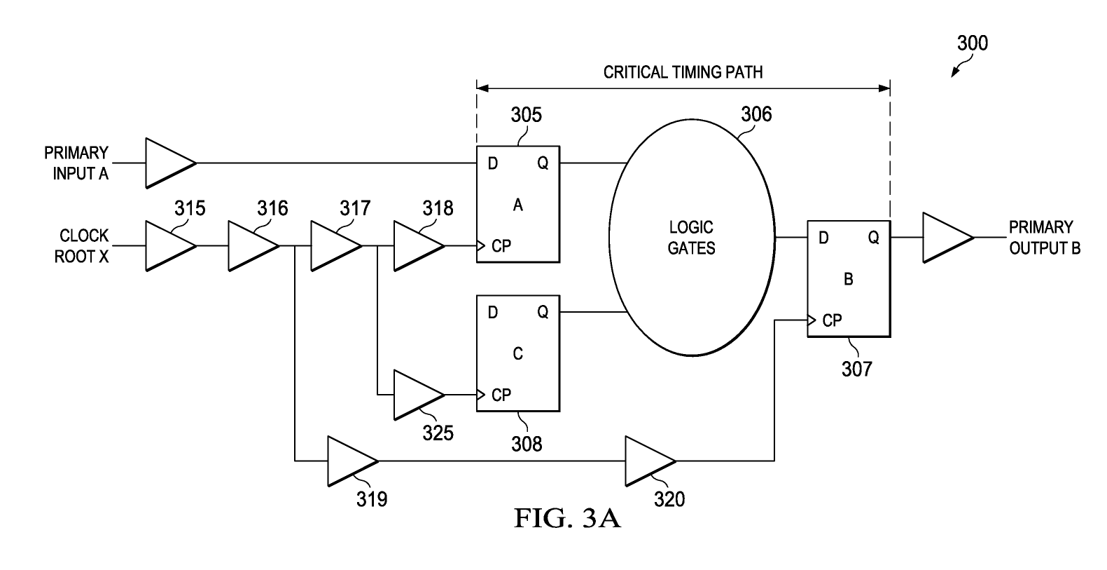

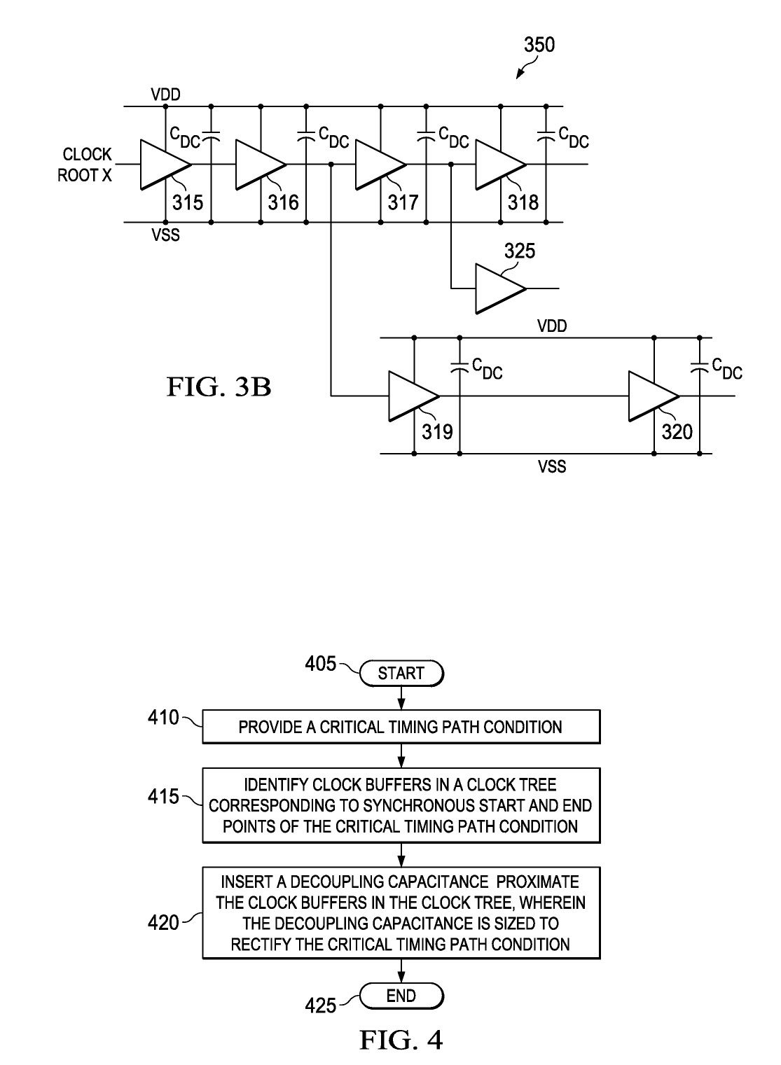

FIG. 3A illustrates an example of a logic diagram, generally designated 300, showing logic and associated clock circuits corresponding to a critical timing path condition;

FIG. 3B illustrates an embodiment of clock buffers in a clock tree that are power decoupled to rectify the critical timing path condition of FIG. 3A; and

FIG. 4 illustrates a flow diagram of an embodiment of a method of clock tree power decoupling carried out according to the principles of the present disclosure.

### DETAILED DESCRIPTION

Embodiments of the present disclosure may employ electronic design automation (EDA) tools. EDA tools are a category of computer aided design (CAD) tools and may be used to create representations of circuit configurations and the interconnections that couple them together. EDA tools allow verification, performance simulation and testing of designs using a computer without requiring the lengthy and costly process of fabrication. These embodiments may be carried out within a module that is part of an EDA tool running on a general purpose computer. In general, the embodiments discussed below may be performed by software running on a general purpose computer.

FIG. 1 illustrates a system diagram of an embodiment of a clock tree power decoupling system, generally designated 100, constructed according to the principles of the present disclosure. The clock tree power decoupling system 100 illustrates an embodiment of the disclosure that jointly provides synthesis of a clock tree and insertion of power decoupling capacitance along the clock tree to correct a critical timing path condition.

Timing margin is defined as the excess time in a clock cycle for a synchronous design to perform properly. It is an expression of the difference between the actual change in a signal and the latest time at which the signal can change in order for a circuit to function correctly. A critical timing path is defined as a functional path having a timing margin that is too small to guarantee proper performance or functioning of the synchronous design.

The clock tree power decoupling system 100 includes a pre-decoupling processor 105, a clock tree power decoupler 115 and a post-decoupling processor 125, as shown. The pre-decoupling processor 105 includes a clock tree specification 106, a physical placement database 107, a timing constraints list 108 and a static timing analyzer 109. The clock tree power decoupler 115 includes a clock tree module 117 and a power decoupling module 119. The post-decoupling processor 125 includes a power-decoupled clock-inserted database 127.

The pre-decoupling processor 105 provides a clock tree that supports a critical timing path condition. The clock tree specification 106 and the physical placement database 107 are employed to synthesize the clock tree. The timing constraints list 108 and the physical placement database 107 are employed by the static timing analyzer 109 to determine that the synthesized clock tree supports functional logic that has a critical timing path condition.

The clock tree power decoupler 115 employs the clock tree module 117 to identify clock buffers (i.e., “critical” clock buffers) in the clock tree synthesized corresponding to synchronous start and end points of the critical timing path condition. The power decoupling module 119 inserts a decoupling capacitance proximate the clock buffers in the clock tree, wherein the decoupling capacitance is sized to rectify the critical timing path condition.

Typically, the decoupling capacitance is inserted between current sourcing and sinking (e.g., V_{DD} and V_{SS}) power supply connections along the clock tree proximate each clock buffer that requires power decoupling. Alternately, a portion of the decoupling capacitance may be inserted between one of the current sourcing and sinking power supply connections and a current return connection (e.g., a common ground connection).

The decoupling capacitance may include multiple separate capacitors connected along the clock tree. Additionally, there may be multiple sizes of decoupling capacitor cells. Typically, there may be a base value decoupling capacitor cell having a certain capacitance and then multiples of this base value (e.g., two, four or eight times base cell value, etc). Multiple decoupling capacitor cells also may be added in parallel to obtain a larger decoupling capacitance.

A decoupling capacitance size or value is usually based on an associated clock buffer size. Correspondingly, the decoupling capacitance value may be based on a charge required to accommodate a dynamic switching current in the clock tree. For example, the dynamic switching current for a given clock buffer can be determined through SPICE characterization during circuit design of the clock buffer. A lookup table for decoupling capacitance size versus clock buffer size or strength may be employed for a clock tree composed of different types or sizes of clock buffers. As each of the clock buffers is addressed, a required decoupling capacitance value or number of decoupling capacitor cells is determined and inserted.

The post-decoupling processor 125 receives a power-decoupled clock tree from the clock tree power decoupler 115 and provides incremental physical placement of newly generated cells along with physical clock tree optimization for the power-decoupled clock tree. The post-decoupling processor 125 then provides a power-decoupled clock-inserted database 127 having all clock trees thereby including those employing decoupling capacitance to rectify critical timing path conditions and those not needing decoupling capacitance. This approach limits decoupling capacitance use to only needed clock trees thereby reducing an overall leakage current that may be obtained from a general application of decoupling capacitance.

FIG. 2 illustrates a system diagram of another embodiment of a clock tree power decoupling system, generally designated 200, constructed according to the principles of the present disclosure. The clock tree power decoupling system 200 illustrates an embodiment of the disclosure that provides selection (rather than synthesis) of an existing clock tree and insertion of power decoupling capacitance along the clock tree to correct a critical timing path condition. Structure and operation of the clock tree power decoupling system 200 generally parallels those of the clock tree power decoupling system 100 of FIG. 1.

The clock tree power decoupling system 200 includes a pre-decoupling processor 205, a clock tree power decoupler 215 and a post-decoupling processor 225, as shown. The pre-decoupling processor 205 includes a clock-inserted database 206, a timing constraints list 207 and a static timing analyzer 208. The clock tree power decoupler 215 includes a clock tree module 217 and a power decoupling module 219. The post-decoupling processor 225 includes a power-decoupled clock-inserted database 227.

The pre-decoupling processor 205 provides a clock tree that supports a critical timing path condition. Here, the clock tree specification 106 is replaced with a clock-inserted database 206 from which a clock tree is selected, and a determination of a critical timing path condition is made. The pre-decoupling processor 205 employs the timing constraints list 207 and the static timing analyzer 208 to determine if the selected clock tree supports the critical timing path condition.

The clock tree power decoupler 215 employs the clock tree module 217 to identify clock buffers (i.e., critical clock buffers) in the clock tree selected corresponding to synchronous start and end points of the critical timing path condition. The power decoupling module 219 inserts a decoupling capacitance proximate the clock buffers in the clock tree, wherein the decoupling capacitance is sized to rectify the critical timing path condition.

The post-decoupling processor 225 receives a power-decoupled clock tree from the clock tree power decoupler 215 and provides incremental physical placement of newly generated cells for the power-decoupled clock tree. The post-decoupling processor 225 then provides a power-decoupled clock-inserted database 227 having all clock tree paths including those employing decoupling capacitance to rectify critical timing margins and those not needing decoupling capacitance.

FIG. 3A illustrates an example of a logic diagram, generally designated 300, showing logic and associated clock circuits corresponding to a critical timing path condition. The logic diagram 300 includes first, second and third registers 305, 307, 308. The first register 306 provides an output to logic gates 306 that in turn provide an output to an input of the second register 307, thereby forming a functional path. The third register 308 also provides an output to the logic gates 306. The logic diagram 300 also includes a group of clock buffers 315-320 in a clock tree (originating from a clock root X) that support the first and second registers 305, 307, and another clock buffer 325 that supports the third register 308.

In the illustrated example, a critical timing path exists starting with the first register 305, continuing through the logic gates 306 and ending with the second register 307. The first register 305 and the second register 307 are designated as respective synchronous start and end points for the critical timing path. The group of clock buffers 315-320 is therefore identified as clock buffers in the clock tree that correspond to the synchronous start and end points of the critical timing path, since they support the first and second registers 305, 307. Clock buffers in the group of clock buffers 315-320 are candidates for decoupling capacitance. The clock buffer 325 does not support the first and second registers 305, 307, and therefore, is not a candidate for decoupling capacitance.

FIG. 3B illustrates an embodiment of clock buffers in a clock tree, generally designated 350, that are power decoupled to rectify the critical timing path condition of FIG. 3A. The embodiment of clock buffers 350 includes the group of clock buffers 315-320 that are candidates for decoupling capacitance. The clock buffer 325 that is not a candidate is also shown.

Each of the group of clock buffers 315-320 is connected to current sourcing and current sinking power supply voltages V_{DD} and Vₛₛ. An individual decoupling capacitor C_{DC} is located proximate each of the group of clock buffers 315-320 thereby forming a decoupling capacitance for the clock tree supporting the first and second registers 305, 307 of FIG. 3A. In the illustrated embodiment, each decoupling capacitor C_{DC} provides the same value of capacitance. However, as discussed earlier, each of the group of clock buffers 315-320 may employ different values of decoupling capacitors, as required.

FIG. 4 illustrates a flow diagram of an embodiment of a method of clock tree power decoupling, generally designated 400, carried out according to the principles of the present disclosure. The method 400 starts in a step 405 and a critical timing path condition is provided in a step 410. Then, in a step 415, clock buffers in a clock tree are identified corresponding to synchronous start and end points of the critical timing path condition. A decoupling capacitance is inserted proximate the clock buffers in the clock tree, wherein the decoupling capacitance is sized to rectify the critical timing path condition, in a step 420.

In one embodiment, the clock tree is synthesized from a clock tree specification in conjunction with a physical placement database. In another embodiment, the clock tree is selected from an existing clock-inserted database. In either of these embodiments, a static timing analysis of a timing constraints list provides the synchronous start and end points of the critical timing path condition.

In yet another embodiment, the decoupling capacitance is inserted between sourcing and sinking power supply connections of the clock buffers. Generally, the decoupling capacitance is sized to provide a capacitance charge required to support a dynamic switching current in the clock tree. Additionally, the decoupling capacitance may include multiple capacitors. The method 400 ends in a step 425.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

1. A clock tree power decoupler, comprising:
a clock tree module configured to identify clock buffers in a clock tree corresponding to synchronous start and end points of a critical timing path condition; and
a power decoupling module configured to insert a decoupling capacitance proximate the clock buffers in the clock tree, wherein the decoupling capacitance is sized to rectify the critical timing path condition.

2. The decoupler as recited in claim 1 wherein the clock tree is synthesized from a clock tree specification in conjunction with a physical placement database.

3. The decoupler as recited in claim 1 wherein the clock tree is selected from an existing clock-inserted database.

4. The decoupler as recited in claim 1 wherein a static timing analysis of a timing constraints list provides the synchronous start and end points of the critical timing path condition.

5. The decoupler as recited in claim 1 wherein the decoupling capacitance is inserted between sourcing and sinking power supply connections of the clock

6. The decoupler as recited in claim 1 wherein the decoupling capacitance includes multiple capacitors.

7. The decoupler as recited in claim 1 wherein the decoupling capacitance is sized to provide a capacitance charge required to support a dynamic switching current in the clock tree.

8. A method of clock tree power decoupling, comprising:
identifying clock buffers in a clock tree corresponding to synchronous start and end points of a critical timing path condition; and
inserting a decoupling capacitance proximate the clock buffers in the clock tree, wherein the decoupling capacitance is sized to rectify the critical timing path condition.

9. The method as recited in claim 8 wherein the clock tree is synthesized from a clock tree specification in conjunction with a physical placement database.

10. The method as recited in claim 8 wherein the clock tree is selected from an existing clock-inserted database.

11. The method as recited in claim 8 wherein a static timing analysis of a timing constraints list provides the synchronous start and end points of the critical timing path condition.

12. The method as recited in claim 8 wherein the decoupling capacitance is inserted between sourcing and sinking power supply connections of the clock buffers.

13. The method as recited in claim 8 wherein the decoupling capacitance includes multiple capacitors.

14. The method as recited in claim 8 wherein the decoupling capacitance is sized to provide a capacitance charge required to support a dynamic switching current in the clock tree.

15. A clock tree power decoupling system, comprising:
a pre-decoupling processor that provides a clock tree that supports a critical timing path condition;
a clock tree power decoupler, comprising:
a clock tree module that identifies clock buffers in the clock tree corresponding to synchronous start and end points of the critical timing path condition, and
a power decoupling module that inserts a decoupling capacitance proximate the clock buffers in the clock tree, wherein the decoupling capacitance is sized to rectify the critical timing path condition; and
a post-decoupling processor that provides a power-decoupled clock-inserted database employing the decoupling capacitance.

16. The system as recited in claim 15 wherein the clock tree is synthesized from a clock tree specification in conjunction with a physical placement database.

17. The system as recited in claim 15 wherein the clock tree is selected from an existing clock-inserted database.

18. The system as recited in claim 15 wherein a static timing analysis of a timing constraints list provides the synchronous start and end points of the critical timing path condition.

19. The system as recited in claim 15 wherein the decoupling capacitance is inserted between sourcing and sinking power supply connections of the clock buffers.

20. The system as recited in claim 15 wherein the decoupling capacitance includes multiple capacitors and has a size that is based on a capacitance charge required to provide a dynamic switching current in the clock tree.
